(19) United States
(12) Patent Application Publication
(10) Pub. No.: US 2020/0216687 A1
(43) Pub. Date: Jul. 9, 2020

(54) RECONSTRUCTION SOLUTION FOR REMOVING COATINGS OF CARCINOGENIC FIBERS USING AN ORGANIC OR INORGANIC CONTRAST AGENT FOR VISUALIZING THE PENETRATION OF HYDROCHLORIC ACID INTO CARCINOGENIC FIBERS

(71) Applicant: KATRIN RUDOLPHI, Berlin (DE)

(72) Inventor: KATRIN RUDOLPHI, Berlin (DE)

(21) Appl. No.: 16/821,500

(22) Filed: Mar. 17, 2020

Related U.S. Application Data
(63) Continuation of application No. 15/771,571, filed on Apr. 27, 2018.

(51) Int. Cl. C09D 9/00; A62D 3/36; A62D 3/38

(52) U.S. Cl. CPC C09D 9/00; A62D 2101/41; A62D 3/38; A62D 3/36

(57) ABSTRACT

A pH-stable dye which allows the penetration of hydrochloric acid into amorphically different carcinogenic fibers used for detection of sprayed asbestos or plastic mineral fibers for fireproofing components. In the process, the continuous colored penetration of the fiber layers is achieved synchronously with the decomposition process of the hydrochloric add. Thus, the progress of the penetration process can be estimated during the reconstruction work, and the task of removing the now spongy layers can be carried out with contrast agents of the following group consisting of organic and inorganic substances such as acridine orange, brilliant cresyl blue, bromophenol blue, eosin Y, erythrosine B, fluorescein, methyl blue, methyl orange, thymol blue, resulting in the even penetration of carcinogenic fibers using hydrochloric acid.

### CROSS-REFERENCES TO RELATED APPLICATIONS

This application is a continuation application of pending U.S. application Ser. No. 15/771,571, which is the U.S. National Stage of International Application No. PCT/DE2015/000529, filed Oct. 30, 2015, which designated the United States and has been published as International Publication No. WO 2017/071675 A1, the description of which is hereby incorporated by reference.

### DESCRIPTION OF THE TECHNICAL FIELD OF THE INVENTION

In the deinstallation of carcinogenic spray compositions, high exposures to fibers have hitherto been produced. The objective was to discover a pH-stable dye which makes it possible to detect the penetration of hydrochloric acid into variously strong amorphous carcinogenic fibers (spray asbestos or synthetic mineral fibers for fire protection on components). Here, continuous penetration of color through the fiber layers should be achieved concurrently with the decomposition process of the hydrochloric acid. In this way, the progress of the penetration process can be estimated during renovation work and the work for removing the now spongy layers can then be carried out more readily. One method is known from DE102012006763B4. The disadvantage of this method is that the contrast agent does not become uniformly distributed in the desired form.

### DESCRIPTION OF THE PRIOR ART KNOWN HITHERTO

The deinstallation of carcinogenic compositions is regulated in detail in the German Hazardous Materials Regulations, in TRGS 519 asbestos, demolition, renovation and repair measures, in TRGS 521 demolition, renovation and maintenance work involving old mineral wool and in the asbestos guidelines. The deinstallation was carried out mechanically and was associated with a great outlay in terms of time. The spray compositions could be removed from the substrates without leaving residues only with difficulty. Costly protective measures and cleaning techniques have been used for this purpose. Cleaning was carried out by ice blasting, time-consuming mechanical cleaning by means of brushes, etc. In the case of components having complicated geometries, the carcinogenic fibers could not be removed without leaving a residue.

### PRESENTATION OF THE TECHNICAL PROBLEM

Due to the lack of innovative methods, the residue-free removal of carcinogenic materials on various substrates was not ensured in the case of the working techniques described. There were no methods available which made it possible to reduce the exposure to fibers, to minimize the manual work, to reduce the hazards, to minimize protection of workers, to improve the renovation results, to shorten the renovation times and to minimize the renovation costs.

After discovery of an innovative renovation technique for dealing with carcinogenic fibers by means of hydrochloric acid, the contrast agent used hitherto was unsatisfactory, It was therefore necessary to carry out further research on optimizing the contrast agent using a broad chemical palette. A problem addressed by the invention is to provide a renovation solution of the abovementioned type which makes improved visibility of the regions possible.

### PRESENTATION OF THE SOLUTION TO THE PROBLEM

The invention has solved this problem by comprehensively analyzing contrast agents from the group consisting of organic and inorganic substances such as acridine orange, brilliant cresyl blue, bromophenol blue, eosin Y, erythrosine B, fluorescein, methyl blue, methyl orange, thymol blue, etc. The advantages of the substances mentioned lie in uniform penetration of carcinogenic fibers with the aid of hydrochloric acid. The studies were carried out hi two substeps. In the first section of the study, asbestos samples were introduced as a coarse bed into polypropylene column bodies. The penetration behavior of various dye solutions was tested on these model packings.

### DETAILED DESCRIPTION OF PREFERRED EMBODIMENTS

Using the knowledge obtained here, six different asbestos samples which were employed in this form hi building and construction were treated in the second part in order to approximate the real conditions. Unless indicated otherwise, 15% strength hydrochloric add was used for all experiments. The selection of the dyes was based on the following criteria:
Solubility in water or adds, storage stability in concentrated adds
Price, toxicity
Color intensity
   A number of working examples of the invention are described below.

Part 1—Selection of the Dyes

The prepared sample columns (diameter 23 mm) contained granular to pulverulent amorphous carcinogenic fibers as a bed which was moderately pressed and had a height of 80-90 mm. In preliminary studies, solubility and coloring behavior of various dyes were tested. All dyes are readily soluble in water. In dilute acids (about 1 M), they are readily likewise soluble or soluble to such an extent that distinctly colored solutions are obtained. No information as to the solubility behavior of the dyes in question in highly concentrated acids is known from the literature. Test solutions in 15% strength hydrochloric acid were therefore made up.

| | Solubility in | | |
|---|---|---|---|
| | 15% strength | | |
| | hydrochloric | | |
| Dye | acid | Color | Disadvantages |
| Acridine orange | readily soluble | orange-red | |
| Brilliant cresyl blue | soluble | dark blue | |
| Bromophenol blue | soluble | dark blue | |
| Eosin Y | readily soluble | orange- | pale color |
| | | yellow | |
| Erythrosine B | soluble | dark blue | |
| Fluorescein | readily soluble | yellowish | pale color |
| | | green | |
| Methyl blue | readily soluble | dark blue | |
| Methyl orange | readily soluble | orange-red | |
| Thymol blue | readily soluble | reddish | color very |
| | | violet | pale on |
| | | | asbestos |

It can be seen from the table that the dyes have properties which are very advantageous for the desired purpose. Fluorescein and methyl orange themselves are only suitable for particular fields of use since the color intensity or the color contrast is very low.

Production of dye solutions as illustrative solution using methyl blue and/or fluorescein:

Solution A: 80 mg of methyl blue in 1000 ml of 15% strength hydrochloric acid (c=0.1 mM)

Solution B: 80 mg of methyl blue (c=0.1 mM) and 66 mg of fluorescein (c=0.2 mM) in 1000 ml of 15% strength hydrochloric acid

Solution C: 400 mg of methyl blue in 1000 ml of 15% strength hydrochloric acid (c=0.5 mM)

Mixtures of methyl blue and fluorescein were also used. Here, a deepening of the color from blue (methyl blue alone) to blackish blue takes place.

Part 2—Studies on Carcinogenic Fibers in Polypropylene Columns

An attempt was made to monitor the penetration of the hydrochloric acid dye solutions into the layers semiquantitatively. Since the material being examined has inhomogeneities due to its nature, the data obtained are only guideline values.

The vertically clamped columns were loaded with dye solution A in 2 ml portions. Vigorous gas evolution occurred here as a result of the reaction with basic constituents (carbonate) of the carcinogenic fibers. A next application of dye solution took place only after gas evolution had stopped. It was ensured that the columns were always covered with liquid at the top. The course over time of penetration into the layer was monitored. At the beginning, very rapid penetration (34 cm in 10-20 min) of the solution into the layer took place. In the case of tightly packed columns, penetration into the layer subsequently slowed significantly. The solutions reached the end of the column after 1-2 hours. This slowing was a result of the chemical reaction occurring between acid and basic carcinogenic fibers. Formation of a homogeneous mass took place and this led to densification of the material in the middle region. On the other hand the solutions ran very much more quickly through loosely packed columns (30 min-1 hour). The volumes of the dye solutions required for complete penetration are naturally determined by the column size, i.e. 40-50 ml. That the chemical reactions occurring, associated with densification of the material, are quite critical for the speed of penetration is shown by the result of the following experiment:

A corresponding dye solution of methyl blue (c=0.1 mM) in water runs through even a firmly packed column within 10 minutes. The liquid which first leaves the column was pH-neutral, which is a result of the neutralization reaction occurring. The solutions running out had a yellow color, which can be explained by decomposition reactions and the leaching of colored substances (salts) from the asbestos. The dye methyl blue traveled more slowly through the column than the liquid front. Adsorption on the asbestos surface thus takes place. Hydrophilic, water-soluble substances naturally interact with siliceous surfaces. The eluate leaving the column after 2-4 hours (in the case of firmly packed columns) is then blue in color and also has an acidic pH.

In order to ensure the complete penetration desired according to the formulation of the problem of the hydrochloric acid penetration phase with the chromophore, the concentration of methyl blue in the solution was increased by a factor of 5. The above-described procedure was then also carried out using the solution C. The higher dye concentration brings about more rapid saturation of the surface. As a result, the dye also runs in the solvent front and reaches the exit of the column together with the liquid.

Experiments on increasing the color intensity of the regions penetrated by hydrochloric acid were carried out using the mixture (solution B) of methyl blue and fluorescein described in part 1. When using the dye mixture B, an even more intensively colored appearance (blackish blue coloration) was actually obtained in comparison with the pure methyl blue solutions. The course of the penetration over time remained unaffected thereby.

Part 3—Studies on Building Materials Containing Carcinogenic Fibers

Six different carcinogenic materials having different binding are to be examined for their penetration capability.

Material Asb 1: Sokalit, board thickness 18 mm; the board has a smooth, more solid upper side and a rougher, somewhat looser underside

Material Asb 2: Board thickness 28-30 mm, moderately pressed material Material KMF 3: Board thickness about 22 mm, very loosely pressed board

The boards were fastened horizontally. The dye solution A was subsequently dripped in portions onto an area of about 1-2 cm2. Further solution A was continually added as soon as all liquid had been absorbed. Only such an amount of solution that the horizontal spread on the surface remained restricted to about 4 cm² was used.

### Results

Material Sokalit

After treatment for 1.5 hours, removal of material (depression) of 1-2 mm was observed (FIG. 3). Consumption: 10 ml of solution A. The total penetration depth of 4 mm (blue coloration) was determined by careful removal of material. After treatment for 1.5 hours, removal of material (depression) of 18 mm was observed. Consumption: 10 ml of solution A. Total penetration depth (blue coloration) 18 mm,

Material Asb. 2, weakly bonded asbestos board

In the case of the commercial asbestos board, complete removal of material (hole formation) was observed after treatment for three minutes.

Material KMF 3: Board thickness about 22 mm, very loosely pressed board

After treatment for 2 hours, solution A had completely soaked the material. After a further hour, a hole had formed and the blue solution dripped through the material. Consumption: 20 ml of solution A, The material was subsequently broken at the point of application.

### Evaluation

On the basis of the preliminary studies on the solubility in 15% strength hydrochloric acid and the assessment of the color intensities, all mentioned organic and inorganic contrast agents could be validated as suitable dye. These are characterized by an intensive color even at low concentrations (at or above 0.1 mM), stability in acids, favorable price and nontoxic nature. In addition, these are likewise sufficiently stable in the treatment of carcinogenic fibers and visibly color the treated materials in the layers which have been penetrated,

Methyl blue has been found to be particularly useful as suitable chromophore for the planned purpose of visualization of the progress of penetration in the treatment of amorphous carcinogenic fibers with hydrochloric acid and the complete coloring of the penetrated layers to be achieved. The use of a concentration of 0.5 mM of methyl blue in 15% strength hydrochloric acid displays good results.

Successful use of tested and specified solutions in the removal of amorphous carcinogenic fibers is thus possible.

While the invention has been illustrated and described as embodied in a rehabilitation solution, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method of using a rehabilitating solution comprising,
applying the rehabilitation solution in the deinstallation of carcinogenic fibers, said rehabilitation solution comprising,
a mixture of hydrochloric acid in a proportion of less than 25% by weight, water and a contrast agent, said solution to remove coatings composed of carcinogenic fibers, wherein the contrast agent is selected from the group consisting of acridine orange, brilliant cresyl blue, methylene blue, bromophenol blue, eosin Y, erythrosine B, fluorescein.

2. The method of claim 1, wherein the hydrochloric acid is 15% by weight.

3. The method of claim 1, wherein the contrast agent is present at a concentration of ≤0.1 mM.

4. The method of claim 1, wherein the carcinogenic fibers are fibers of asbestos.

5. A method of producing a rehabilitation solution for use with a method of claim 1 wherein the solution contains 80 mg of methyl blue in 1000 ml of 15% hydochloric acid.

6. The method of claim 5, wherein the solution further comprises 66 mg of fluorescin.
